(19) United States
(12) Patent Application Publication
(10) Pub. No.: US 2019/0028584 A1
(43) Pub. Date: Jan. 24, 2019

(54) Functional Case for Portable Electronic Device

(71) Applicants: John Duffin, Medway, MA (US); Rowena I. White, Bridgeport, CT (US)

(72) Inventors: John Duffin, Medway, MA (US); Rowena I. White, Bridgeport, CT (US)

(21) Appl. No.: 16/040,723

(22) Filed: Jul. 20, 2018

Related U.S. Application Data
(60) Provisional application No. 62/534,804, filed on Jul. 20, 2017.
(60) Provisional application No. 62/650,760, filed on Mar. 30, 2018.

(51) Int. Cl. H04M 1/725; H04B 1/3888; G01G 7/00; G01G 21/28; G01S 17/08

(52) U.S. Cl. CPC H04M 1/72577; H04B 1/3888; H04M 1/72527; H04M 2250/12; G01G 7/00; G01G 21/28; G01S 17/08; H04M 1/72569

(57) ABSTRACT

A functional case for a portable electronic device. There is a case that is adapted to be coupled to the portable electronic device, one or more sensors built into the case, wherein the sensors are configured to detect the weight of an item placed onto the case and wherein the sensors output sensor data, and a processor that is functionally coupled to the sensors, for receiving sensor output data and determining the weight of the item, and transmitting the weight to a display associated with the case or associated with another device.

### CROSS-REFERENCE TO RELATED APPLICATIONS

This application claims priority of Provisional Application 62/534,804 filed on Jul. 20, 2017, and Provisional Application 62/650,760 filed on Mar. 30, 2018. The disclosures of both applications are incorporated herein by reference in their entireties.

### BACKGROUND

Smartphones, tablets and other portable electronic device are ubiquitous. Since these devices are usually readily available to people, their usefulness can be enhanced by adding functionalities that are not already part of the device.

### SUMMARY

All examples and features mentioned below can be combined in any technically possible way.

This disclosure features a functional case for a portable electronic device such as a smartphone or tablet, for example. The case is adapted to be physically coupled to the portable electronic device, as is a normal protective case. One or more electronic sensors are built into the subject case. In one example, these sensors are configured to detect the weight of an item placed onto the case. The sensors may comprise piezoelectric sensors, or strain-based weighing sensors, for example. A processor is also built into the case. The processor is functionally coupled to the sensors, for receiving sensor data. The functional coupling between the sensors and the processor can be wireless or can use wires that connect the sensors to the processor and are built into the case. The processor is configured to determine the weight of the item, and transmit the weight to a display associated with the case, and/or a display associated with another device. The case can further include the ability to accept an insertable module, such as a breathometer, a thermometer, and/or a mechanical device. Other devices and functions can be built into the case or carried by the case.

### BRIEF DESCRIPTION OF THE DRAWINGS

FIGS. 1-3 are perspective views of a protective case for a portable electronic device, where the case is able to measure weight, and be used to visually measure length, according to embodiments of the present invention.

FIG. 1 is a top disassembled view of a portable electronic device and an example of an accompanying portable electronic functional protective case.

FIG. 2 is a schematic view of embedded weight measuring sensors such as piezoelectric sensors (used to measure weight of objects in contact with a portable electronic protective case and also to provide voltage to power a portable electronic protective case) and/or resistance strain weighing sensors (used to measure weight of objects in contact with a portable electronic protective case). It should be noted that the portable electronic protective case is like a standard phone or tablet case, but with weight sensors and other electronics built-in as described herein.

FIG. 3 is a perspective view of a microchip embedded within a portable electronic protective case used to process weight and other digital measurements and also to wirelessly transmit weight and other measurements via wireless connectivity such as Bluetooth to a portable electronic device or any other Internet of Things (IoT) electronic device according to one embodiment of the present invention. FIG. 3 also shows a digital display such as an embedded LED within a portable electronic protective case able to display weight directly from the portable electronic protective case according to one embodiment of the present invention.

FIG. 4 is a perspective view of an insertable module (e.g. a breathometer module used to take health-related measurements or other insertable miniature tools such as can be found for example in a Swiss Army knife such as scissors, a bottle opener, or a corkscrew).

FIG. 5 illustrates a display of a mobile application (app) on a portable electronic device that is able to wirelessly receive measurement data from a portable electronic protective case and is able to Application Program Interface (API) with other 3rd party applications.

FIG. 6 is a functional block diagram of a system (e.g., a weight measurement and display system) using the subject functional case.

FIG. 7 is an end view of a portable electronic device and an accompanying portable electronic functional protective case that holds a laser measurement device.

FIG. 8 illustrates the use of eye hooks in a protective case.

### DETAILED DESCRIPTION

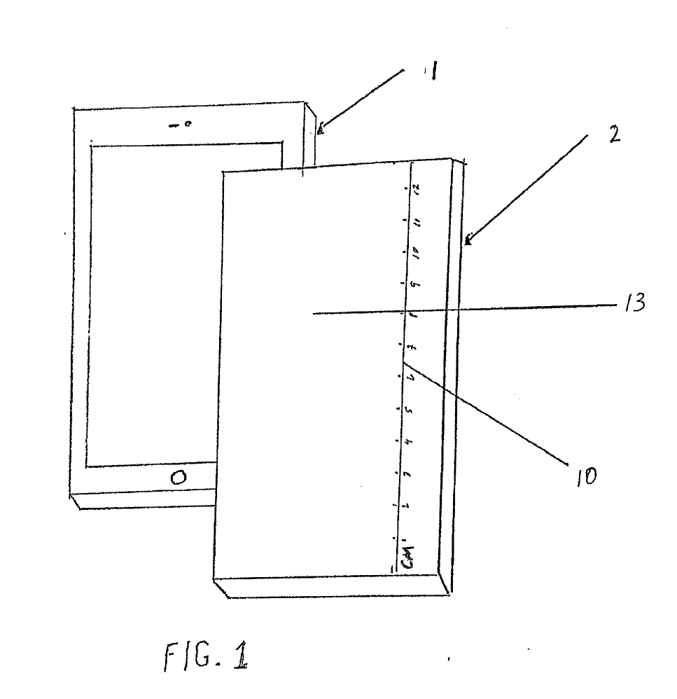

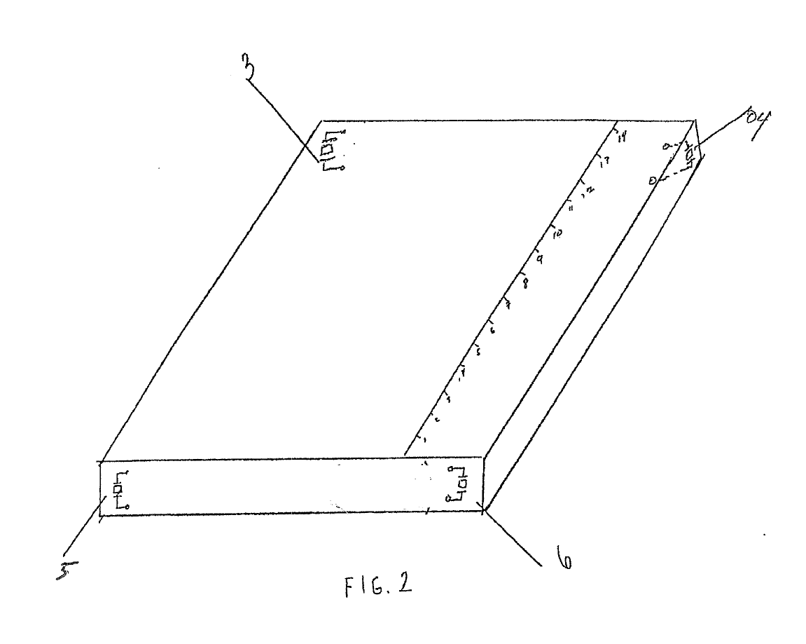

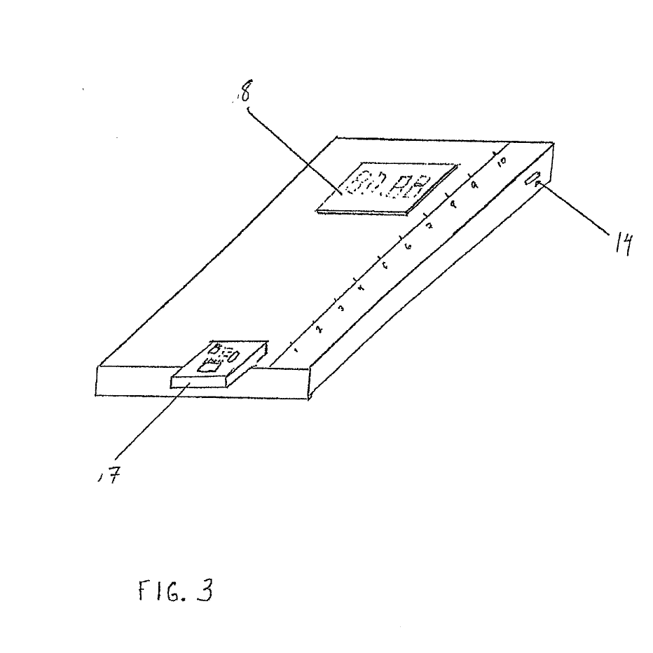

Below, the embodiments are described in detail to demonstrate the technical contents of the present invention. Refer to FIG. 1 and FIG. 2 respectively a top down view and a side view of a portable electronic protective case 2 that is able to measure weight according to one embodiment of the present invention and also to allow a user to visually measure lengths using printed or etched scale 10 on the outside of the case according to one embodiment of the present invention. The portable electronic protective case is like a traditional standard protective case for a mobile device and/or tablet, with the additional features built into the case that enable the case to measure weight and length as well as measure health-related measurements such as blood alcohol content via the insertable modules. The present invention comprises an internal electronic component for processing, power, and wireless capabilities such as a microchip 7 (FIG. 3), an internally-housed weight sensor 3-6 (that can use any weight or load-sensing technology, including but not limited to a load sensor) and a display panel 8. Sensors 3-6 are depicted schematically.

The portable electronic protective case 2 may be comprised of a single solid body member with one or more non-removable and/or removable internal components. It should be elucidated that the electronic device 1 that the portable electronic protective case attaches onto (similar to the encapsulating method that a user deploys to attach any traditional standard protective case for mobile devices and/or tablets) is a tablet, a smartphone, a notebook computer, a mobile communication device, an audio/visual player, a game machine, or any other relevant Internet of Things (IoT) device. The one body member (protective case) 2 has an upper surface 13, which is flat. Items to be weighed can be placed on surface 13, and the weight is then measured by the sensors 3-6 built into the portable electronic protective case 2. The weight is computed, processed, and transmitted by the microchip 7. The display panel 8 is arranged on the top of the platform 13, displaying the weight data of the object carried by the platform. An additional feature can be a hook that is normally located inside the case and is functionally coupled to the weight sensor(s). The hook can be deployed from the case and an item to be weighed (e.g., luggage) can be hung from the hook and weighed.

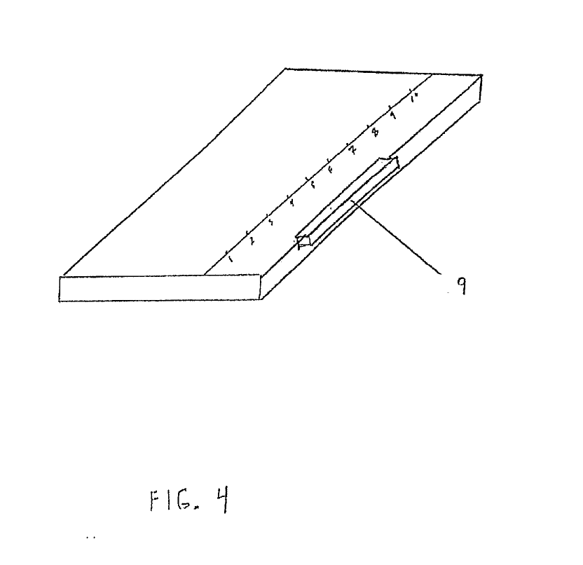

Any measurement, whether it be weight, length, or measurements taken by the insertable modules, can be taken with or without the portable electronic protective case attached to the portable electronic device. In other words, measurements can be taken by the stand-alone case itself (with the option to wirelessly transmit the measured data to a portable electronic device). At least one control key 14, FIG. 3, such as a power switch or “ready to measure” switch, is arranged in the perimeter of the portable electronic protective case 2. The weight sensor 3-6 is disposed inside the single body member 2 and used to weigh the object on top of the platform 13. The weight sensor 3-6 can be arranged at the four corners of the portable electronic protective case 2, as shown in FIG. 2. The weight sensors/transducers are used to measure the weight of the object on top of the platform 13. The weight signal is transmitted to the display panel 08 and/or to the portable electronic device or IoT device via wireless technology such as Bluetooth. The display panel 8 receives the weight signal in a wired way or a wireless way and locally displays weight data. When intending to measure weight, the user activates the scale functionality using switch 14 and turns on the power. Whether an object is placed on the platform 13 or not, the external forces of pressure, either intentionally or unintentionally as when pressed in the pocket of a user's trousers, applied to the portable electronic protective case will produce piezoelectric voltage that will power the overall operations of the portable electronic protective case, including the display panel 8, the microchip 7 (with or without an internal battery component, which may comprise a rechargeable battery power source or another type of internal power source) and the insertable module 9 (FIG. 4). In order to enhance the environmentally-friendly aspects of the portable electronic protective case 2, the casing of the single body member is made of a material that is uneasy to crack, such as renewable or biodegradable plastic material. The embodiments described above are only to exemplify the present invention but not to limit the scope of the present invention. Any equivalent modification or variation according to the claims and specification of the present invention is to be also included within the scope of the present invention.

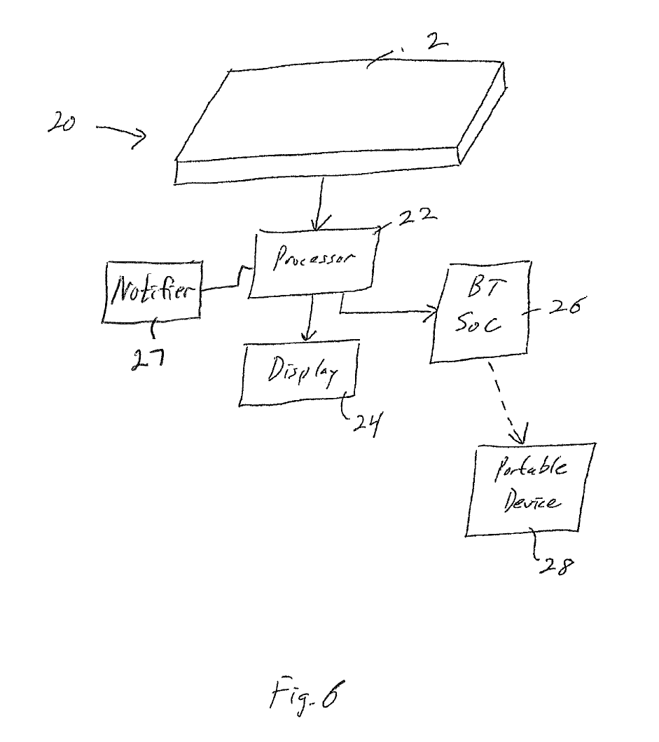

In one example, the system can be used as follows. The user would open an appropriate app on the smartphone or tablet. The app then turns on the weight sensors that are built into the case via wireless commands sent to the processor in the case. The app would also automatically command the device to enter “airplane mode” where the device is disabled from receiving or sending cellular data, Wi-Fi and Bluetooth signals. This prevents the device from issuing electromagnetic waves that could interfere with the digital weight scale operation. Scales are strongly affected by magnetic fields and this radiation will also affect the accuracy of any digital scale, as the display on the scale will change dramatically if it picks up the radio signal of a mobile phone. This happens to every brand electronic scale to different degrees depending on design. Scales will pick up this interference from up to 15 feet away. Once the weight reading has been taken by the case, the case can create an optional output that notifies the user (e.g., via a beep, light, or vibration of the case—see optional “notifier” element 27, FIG. 6), and the user can tap a “view results” button on the display. Alternatively, rather than using a notifier element, after the user has placed the item to be weighed on the case the user can simply interface with the app to calculate weight and then to view measurement results, e.g., by tapping a “view results” button on the display. Once the user has interacted with the app, the app would command the device out of airplane mode so that the device is able to receive the calculated weight via the wireless module of the case. The weight is then displayed by the app.

FIG. 6 illustrates functional aspects of weighing system 20 that uses case 2 with built-in weight sensors, as described above. Processor 22 receives data from the weight sensors (not shown in this figure) and calculates weight or force. This information is provided to one or both of display 24 (which can be on the case, or on the portable device, or on another device) and Bluetooth System on a Chip (BT SoC) 26, which is one means of wirelessly transmitting data to portable device 28.

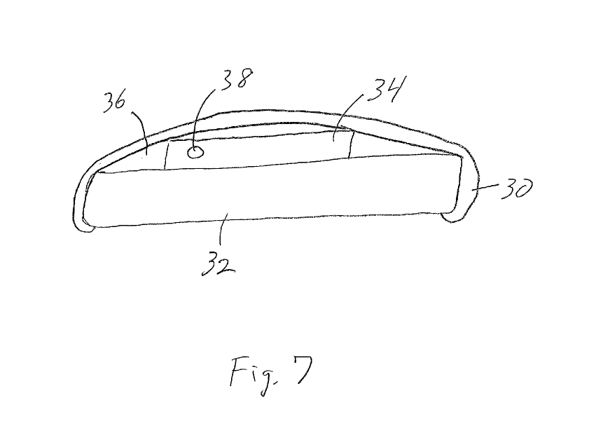

FIG. 7 illustrates additional features of case 30 that fits over portable electronic device (e.g., smartphone) 32, similar to that shown in FIG. 1. Case 30 can be sized and shaped to hold necessary electronics and other aspects of the functionalities that are enabled by the case (not shown). In this example, case 30 is expanded from a flat form into an expanded (e.g., domed) form, as indicated by domed end 36. This creates extra volume in the case. Additional functional modules can be located in this volume. One functionality that can be carried in this extra volume is distance measuring technology module 34 that is arranged to be carried inside case 30. The measuring laser projects out of opening 38 in the case. This case can modify a smartphone to allow it to be used to measure distances. Examples can be in the construction trade and real estate, where the device can be used to measure room dimensions, for example.

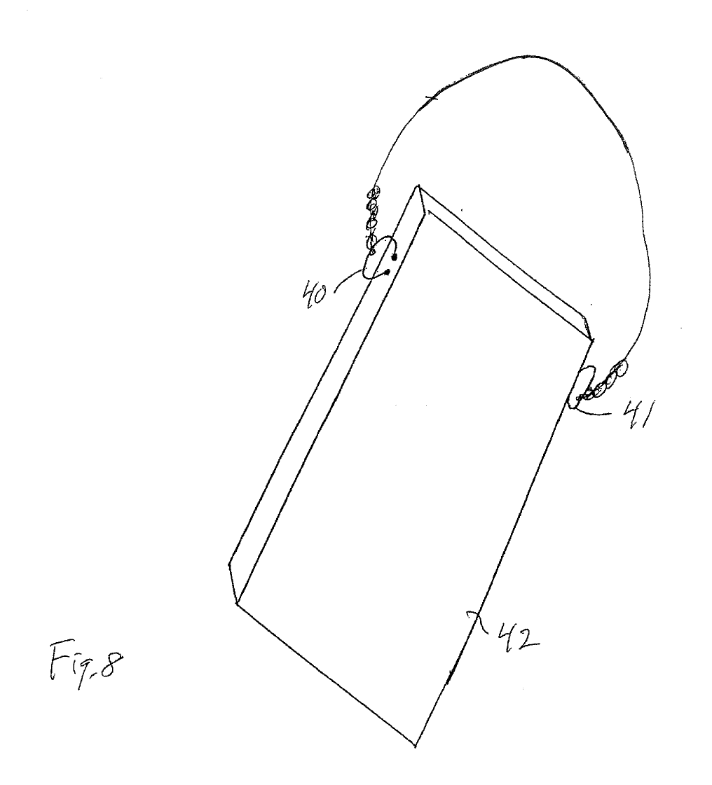

FIG. 8 illustrates spaced eye hooks 40 and 41 on case 42. The eye hooks can be fixed, or they can be deployable such that they are normally stored in the case but movable to the positions shown in the drawing. A necklace or other elongated cord can be coupled to the eye hooks as shown, to allow the case and phone to be hung around the neck or hung from another object or structure.

Further description of the embodiments and applications of a portable electronic protective case are described below.

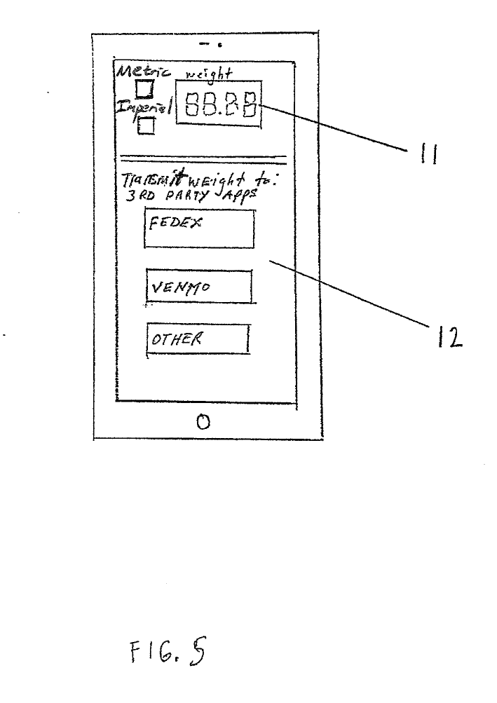

The weight sensors incorporated into the weighing apparatus described in the portable electronic protective case are capable of calculating weights between various ranges. For example, four sensors of differing range capabilities such as piezoelectric and strain gauge could be simultaneously connected within the weighing apparatus to the weighing surface. As an example, when the portable electronic protective case is laid flat on a solid surface, an object stably and entirely resting on the platform 13 can be measured, its weight can be displayed using metric, imperial or any other unit of weight or force measurement. See FIG. 5. The weighing apparatus incorporated into the device provides a weight value, which can be shared with other applications. As an example, the weight of a recipe ingredient placed on the portable electronic protective case could be measured, and that data could be used in conjunction with any IoT device, such as a blender, to calculate the amounts and proportions required to make a recipe.

The weight values could be shared via the app 12 with a 3rd party API. This API would allow an application to retrieve the current static load being applied or any historical record of weight amounts calculated in the past. Applications may include any running directly on the device, or others running on networked computers or devices, including the cloud, which were granted access via the API to the weight values measured by the portable electronic protective case.

In one embodiment, the portable electronic protective case would be useful in business, where for example, a buyer of a commodity such as herbs might be interested in an objective weight measurement prior to completing the transaction, in order to be assured they are getting as much of the herbal product being purchased as the seller indicates.

In one embodiment, the portable electronic protective case could be used with an insertable module such as a breathometer module used to take health-related measurements such as testing alcohol levels, testing for diabetes or halitosis and other breath-related health measurements. Such modules are well known in the field and so are not further described herein. The insertable module is not defined or constrained to only health-related measurements and could be used for supplying additional computational memory or battery power for the portable electronic device or the IoT device. The insertable module could also be a thermometer. Further, the insertable module could be a mechanical device such as a corkscrew or a pen-knife or the like.

In one embodiment, the portable electronic protective case would be useful to measure the weight of a human being, in order for individuals and/or health-care workers to manage health-related issues. The computation abilities of the app stored on the portable electronic device in conjunction with the portable electronic protective case would enable benefits such as storing historical measurements, computing weight relative to manual data inputs such as calories consumed or other sensor inputs such as physical exercise recorded. Data networking capabilities of modern smart phones and tablets, either of which could serve as the basis for a portable electronic protective case could also enable the instant transmission of weight measurements to remote locations for purposes or medical monitoring, social networking diet progress updates, marketing or other research.

In one embodiment, the portable electronic protective case can include force sensors used to measure a force placed against it. For example, in physical rehabilitation to measure the strength of a person after an injury or for insuring that the proper force is applied for the best treatment on the injury. In this embodiment, the portability of the device makes it a practical option relative to bespoke and limited availability rehabilitation equipment.

In one embodiment, the portable electronic protective case could be used in an educational tool for teaching math concepts, or measuring components of a chemistry or science experiment to ensure that the correct amount of elements or compounds are used in an experiment and/or the correct length measurements are taken using the etched-on ruler function 10.

In one embodiment, a portable electronic protective case would be useful in measuring carry-on luggage to be assured that it is under the weight limit or to calculate charges applied by airlines for luggage over established weight allowances. Although similar purpose-built devices exist, it would be convenient for the user to take advantage of this capability if available in a device that would have been carried all the time, such as a portable electronic protective case.

In another embodiment, the portable electronic protective case would be useful in measuring the weight of a letter or package for the purposes of ascertaining postage charges. When combined with software provided by shipping companies, a portable electronic protective case could permit a user to address, calculate and purchase appropriate postage using the portable electronic protective case capabilities in conjunction with an app stored on the portable electronic device 1.

In one embodiment, the portable electronic protective case could be useful in a home or professional kitchen to adjust recipes based upon the availability, or volume, of a single ingredient such as herbs or vegetables. The weight data of one item could interface with the app that then recalculates the measurements of the other ingredients in the recipe to obtain an optimum ratio. Again, the convenience of having this capability in a multipurpose combination of device and case—likely to be on hand at all times—compares positively against needing a purpose-specific weighing device.

In other embodiments, one or more electronic devices such as a flashlight (e.g., a high-powered flashlight), a sound transducer, and/or a mini-projector can be carried by the case (e.g., carried by the case as shown in FIG. 7) and functionally coupled to the smartphone/tablet, as described above.

The above description of example embodiments does not define or constrain this disclosure. Other changes, substitutions, and alterations are also possible without deviating from the overall scope of this disclosure.

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram, the steps may be performed by one element or a plurality of elements. The steps may be performed together or at different times. The elements that perform the activities may be physically the same or proximate one another, or may be physically separate. One element may perform the actions of more than one block. Audio signals may be encoded or not, and may be transmitted in either digital or analog form. Conventional audio signal processing equipment and operations are in some cases omitted from the drawing.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

What is claimed is:

1. A functional case for a portable electronic device, comprising:
a case that is adapted to be coupled to the portable electronic device;
one or more sensors built into the case, wherein the sensors are configured to detect the weight of an item placed onto the case and wherein the sensors output sensor data; and
a processor that is functionally coupled to the sensors, for receiving sensor output data and determining the weight of the item, and transmitting the weight to a display associated with the case or associated with another device.

2. The functional case of claim 1, wherein the case is constructed and arranged to hold an insertable module.

3. The functional case of claim 2, wherein the insertable module comprises a breathometer or a thermometer or a mechanical device.

4. The functional case of claim 1, wherein the sensors comprise piezoelectric sensors.

5. The functional case of claim 1, wherein the sensors comprise strain-based weighing sensors.

6. The functional case of claim 1, wherein the case has four corners and there are four weight sensors, one built into each corner of the case.

7. The functional case of claim 1, wherein the portable electronic device comprises an app that is enabled to turn on the sensors via wireless commands sent to the processor of the case.

8. The functional case of claim 7, wherein the app automatically commands the portable electronic device to disable the sending or reception of cellular data, Wi-Fi and Bluetooth signals.

9. The functional case of claim 8, wherein once the weight reading has been taken, the case creates an output that notifies the user.

10. The functional case of claim 9, wherein the app then automatically commands the portable electronic device to enable the sending or reception of cellular data, Wi-Fi, and Bluetooth signals so that the device is able to receive the calculated weight from the case.

11. The functional case of claim 10, wherein the weight is shared via the app with a third-party API.

12. The functional case of claim 11, wherein the API allows an application to retrieve the current static load being applied to the case or any historical record of weight amounts that were previously determined.

13. The functional case of claim 12, wherein the application is running on the portable electronic device or a different device or networked computer.

14. The functional case of claim 1, wherein the case is dome-shaped to include extra volume in the case in which a functional module can be located.

15. The functional case of claim 14, wherein the functional module comprises a laser-based distance measuring module that comprises a measuring laser that projects out of an opening in the case.

16. The functional case of claim 1, wherein the sensors are wirelessly coupled to the processor and the processor is wirelessly coupled to the portable electronic device.

17. The functional case of claim 16, wherein the portable electronic device comprises an app that is enabled to turn on the sensors via wireless commands sent to the processor of the case, wherein the app automatically commands the portable electronic device to disable the sending or reception of cellular data, Wi-Fi and Bluetooth signals, wherein once the weight reading has been taken the case creates an output that notifies the user and wherein the app then automatically commands the portable electronic device to enable the sending or reception of cellular data, Wi-Fi and Bluetooth signals so that the device is able to receive the calculated weight from the case.

18. A functional case for a portable electronic device, comprising:
a case that is adapted to be coupled to the portable electronic device;
distance measuring laser technology carried inside the case and arranged to use a laser to measure distances; and
a processor that is functionally coupled to the distance measuring laser technology and is configured to calculate and display distance on a display associated with the case or associated with another device.

19. A functional case for a portable electronic device, comprising:
a case that is adapted to be coupled to the portable electronic device and has four corners;
four sensors built into the case, one in each corner, wherein the sensors are configured to detect the weight of an item placed onto the case and wirelessly output sensor data, wherein the sensors comprise piezoelectric sensors or strain-based weighing sensors;
a processor that is wirelessly functionally coupled to the sensors, for receiving sensor output data and determining the weight of the item, and transmitting the weight to a display associated with the case or associated with another device; and
an app in the portable electronic device that is enabled to turn on the sensors via wireless commands sent to the processor.
